(19) United States
(12) Patent Application Publication
(10) Pub. No.: US 2025/0110710 A1
(43) Pub. Date: Apr. 3, 2025

(54) DATA PROCESSING FOR OPERATING ONE OR MORE APPLICATION DEVELOPED BY CODELESS PLATFORM

(71) Applicant: NB Ventures, Inc. DBA GEP, Clark, NJ (US)

(72) Inventors: Subhash Makhija, Westfield, NJ (US); Nithin Maruthi Prasad, Avenel, NJ (US); Huzaifa Matawala, Princeton, NJ (US); Shivendra Singh Malik, Vasco-da-Gama (IN)

(21) Appl. No.: 18/478,396

(22) Filed: Sep. 29, 2023

(51) Int. Cl. G06F 8/35; G06F 8/77

(52) U.S. Cl. CPC G06F 8/35; G06F 8/77

(57) ABSTRACT

The present invention provides a data processing system and method for operating one or more enterprise applications developed by a codeless platform. The invention includes a layered platform architecture for supporting and executing data processing in enterprise applications. The data processing system and method provides generation of one or more scenarios by a bot utilizing a domain model structure and at least one application module for execution of one or more operations associated with the one or more scenarios.

### BACKGROUND

### 1. Technical Field

The present invention relates generally to application developed by codeless platform. More particularly, the invention relates to data processing for operating one or more enterprise applications developed by a codeless platform.

### 2. Description of the Prior Art

Enterprise application processes have become complex over time. The technical problems associated with execution of tasks have become even more challenging due to dynamically changing landscape of functionalities executed through the enterprise applications. Moreover, for enterprise applications developed through codeless platforms the underlining architecture remains unsupportive in multiple aspects including working with different data abstraction. Integration of multiple functions while dealing with distinct data abstractions without impacting functionality of the applications is cumbersome to design. Since, the structure of such applications developed on codeless platform have inherent issues, any changes in the functionalities to be executed in the enterprise application complications the process flows as identification of appropriate technical solution for overcoming the complex process executions.

Codeless platform empowers users to manage new or existing attributes, modify enterprise application functional process, configure rules and workflow. However, in codeless platform attributes are dynamic and driven by random modifications in the process flows, so defining prioritization rules for enterprise application task management process execution on different criterions becomes challenging.

Further, legacy systems have separate components responsible for accepting transaction objects as tasks based on enterprise application processes performed in the existing application flows or other dependent components. Since there is no visibility, any enterprise application task management process operates as a secondary component and does not have any context regarding creation of the process flows for the user. For every change in the transaction, separate integration is required to send revised transaction objects to either update the tasks assigned to a user by the system or cancel tasks. This approach presents numerous technical issues and requires multiple integration points from enterprise application, components with tasks.

Moreover, the applications developed through codeless platform may have been developed by reusable codes, but these codes are restricted in their functionality due to underlining architecture and thereby create technical issues in data processing for certain functionality in the enterprise application, particularly when the functionality is dealing with dynamic data and changing flows. In such a scenario, the system is unable to make sense of the change in the flow and identify associated task modifications which disrupts the entire execution cycle of the enterprise application functions. This is also due to the fact that most of the existing applications use a relational database (RDBMS) as part of the architecture for providing transactional support. RDBMS leads to a big monolith at the storage level and its use to build logic causes inherent technical issues resulting in inefficient functioning of complex application functions. Since, system is unable to identify task modifications and there are inherent technical issues, it leads to inefficient functioning of complex application functions.

None of the prior arts address structural complexity, technical issues in executing functions and identifying task modifications in an enterprise application that are supported by existing architecture designs and infrastructure.

In view of the above problems, there is a need for a system and method of data processing for operating enterprise applications developed by codeless platform that can overcome the problems associated with the prior arts.

### SUMMARY

According to an embodiment, the present invention provides a data processing system and method for operating one or more applications developed by codeless platform. The method includes the steps of receiving one or more application data at a server, identifying by one or more identification bot, at least one relevant data from the received one or more application data wherein each of the one or more identification bot is embedded to at least one of the one or more application, generating one or more scenario by a bot coupled to an AI engine wherein at least one application module created or modified based on a codeless platform and the at least one relevant data provides a domain model structure of the at least one application module for generating the one or more scenarios; and analyzing the one or more scenario, one or more user data associated with the one or more scenario, at least one operational logic, and one or more operation execution conflict to generate for execution one or more operations associated with the one or more scenario.

In an embodiment, the domain model includes one or more application entities with their relationship to other entities represented by associations wherein one or more annotations connected to the domain model enables identification of means by which the domain model is to be operated. The domain model structure captures operational information and operational rules associated with the at least one application module and the one or more applications.

In an embodiment, the present invention provides creating at least one training relationship data model from a data relationship tool by retrieving the historical data elements from the historical data elements database; cleansing the historical data elements for obtaining normalized historical data; extracting a plurality of categories from the normalized historical data for creating taxonomy of relationships associated with the one or more data attributes; fetching a plurality of code vectors from the normalized historical data wherein the code vectors correspond to each of the extracted categories of the relationships; extracting a plurality of distinct words from the normalized historical data to create a list of variables; transforming normalized historical data into a training data matrix using the list of variables, and creating the training relationship data model from the classification code vectors and the training data matrix by using the machine learning engine (MLE) and the AI engine.

In an embodiment, the codeless development platform of the invention includes a plurality of configurable components; a customization layer; an application layer; a shared framework layer; a foundation layer; a data layer; a process orchestrator; and at least one processor configured to cause the plurality of configurable components to interact with each other in a layered architecture to customize the one or more Supply Chain Management (SCM) application based on at least one operation to be executed using the customization layer; organize at least one application service of the one or more Supply Chain Management (SCM) application by causing the application layer to interact with the customization layer through one or more configurable components of the plurality of configurable components, wherein the application layer is configured to organize the at least one application service of the one or more Supply Chain Management (SCM) application; fetch shared data objects to enable execution of the at least one application service by causing the shared framework layer to communicate with the application layer through one or more configurable components of the plurality of configurable components, wherein the shared framework layer is configured to fetch the shared data objects to enable execution of the at least one application service, wherein fetching of the shared data objects is enabled via the foundation layer communicating with the shared framework layer, wherein the foundation layer is configured for infrastructure development through the one or more configurable components of the plurality of configurable components; manage database native queries mapped to that at least one operation using a data layer to communicate with the foundation layer through one or more configurable components of the plurality of configurable components, wherein the data layer is configured to manage database native queries mapped to the at least one operation; and execute the at least one operation and develop the one or more Supply Chain Management (SCM) application using a process orchestrator to enable interaction of the plurality of configurable components in the layered architecture.

In an advantageous aspect, the codeless platform architecture developing the application is a layered architecture that is structured to execute a plurality of complex SCM enterprise application operations in an organized and less time-consuming manner due to faster processing as the underlining architecture is appropriately defined to execute the operations through shortest path. Further, the data processing for operating the one or more applications developed by the platform architecture utilizes domain model structures to generate scenarios for execution and since the platform enables secured data flow through applications and resolution of code break issues without affecting neighboring functions or application, the execution of the scenarios is seamless and error free.

In another advantageous aspect, the present invention utilizes Machine Learning algorithms, prediction data models, artificial intelligence-based process orchestrator for data processing to operate one or more enterprise or Supply chain management application.

### BRIEF DESCRIPTION OF THE DRAWINGS

The disclosure will be better understood when consideration is given to the drawings and the detailed description which follows. Such description makes reference to the annexed drawings wherein:

FIG. 1 is an architecture diagram of a data processing system configured for operating one or more applications developed by a codeless platform in accordance with an embodiment of the invention.

FIG. 2 is a block diagram depicting a field analyzer of the data processing system in accordance with an embodiment of the invention.

FIG. 3 is a flow diagram depicting data analyzer of the data processing system in accordance with an embodiment of the invention.

FIG. 4 is a domain model structure of the data processing system in accordance with an embodiment of the invention.

FIG. 5 is a process flow diagram of task management system in accordance with an embodiment of the invention.

FIG. 6 is a flow diagram depicting determination of task priority in the data processing system in accordance with an embodiment of the invention.

FIG. 7 is a K-means Clustering map of the data processing system in accordance with an embodiment of the invention.

FIG. 7A is a block diagram of data model evaluation and deployment in accordance with an embodiment of the invention.

FIG. 7B is a graph providing output of determining priority of an event in accordance with an embodiment of the invention.

FIG. 8 is a block diagram providing NLP technique with data attribute weight assignment in accordance with an embodiment of the invention.

FIG. 9 is a neural network of the data processing system in accordance with an embodiment of the invention.

FIG. 10 is a graph network showing the paths from each node of the network in accordance with an embodiment of the invention.

FIG. 11 is a table showing shortest path for reaching from one node of a graph network to another node in accordance with an embodiment of the invention.

FIG. 12 is a data network diagram configured to execute operations of the task management data processing system in accordance with an embodiment of the invention.

### DETAILED DESCRIPTION

Described herein are the various embodiments of the present invention, which includes system and method of data processing for operating one or more enterprise and supply chain management applications developed by codeless platform.

The various embodiments including the example embodiments will now be described more fully with reference to the accompanying drawings, in which the various embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “customization layer,” “application layer,” “foundation layer” or “data layer,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures.

The subject matter of various embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, the various embodiments including the example embodiments relate to data processing system and method for operating one or more enterprise or supply chain applications developed by codeless platform architecture.

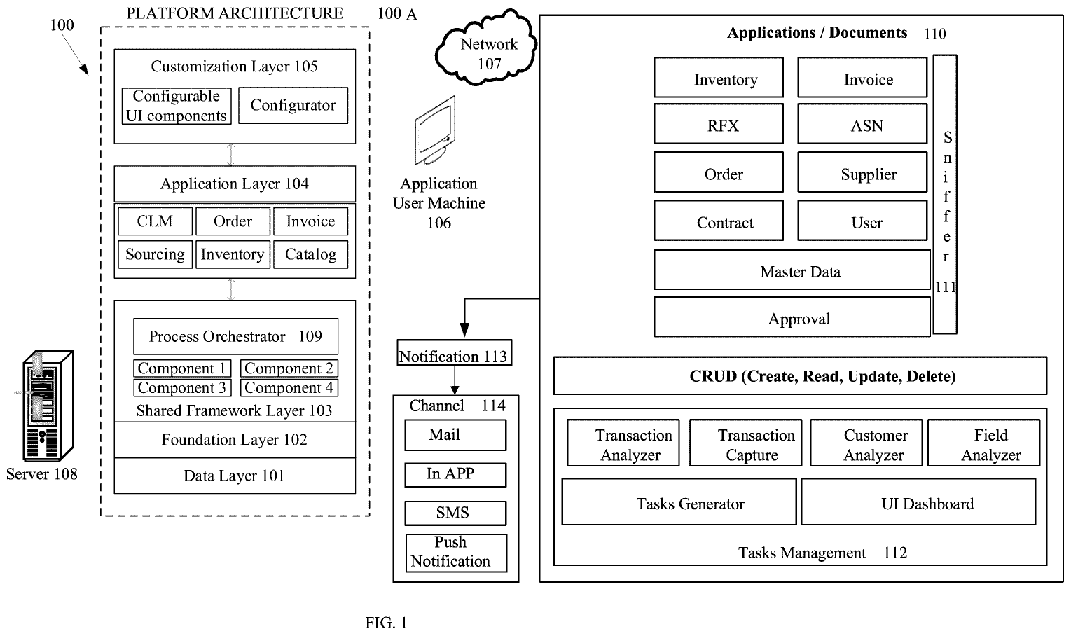

Referring to FIG. 1, an architecture of a system operating one or more applications developed by codeless platform is provided in accordance with an embodiment of the present invention. The architecture is a layered architecture 100 configured to process complex operations of one or more applications including supply chain management (SCM) applications using configurable components of each layer of the architecture 100. The layered architecture enables faster processing of complex operations as the workflow may be reorganized dynamically using the configurable components. The layered architecture 100 includes a data layer 101, a foundation layer 102, a shared framework layer 103, an application layer 104 and a customization layer 105. Each layer of the architecture 101 includes a plurality of configurable components interacting with each other to execute at least one operation of the SCM enterprise application. It shall be apparent to a person skilled in the art that while FIGS. 1 and 1A provide essential configurable components, the nature of the components itself enables redesigning of the platform architecture through addition, deletion, modification of the configurable components and their positioning in the layered architecture. Such addition, modification of configurable components depending on the nature of the architecture layer function shall be within the scope of this invention.

In an exemplary embodiment, the configurable components enable an application developer user/citizen developer, a platform developer user and a SCM application user working with the SCM application to execute the operations to code the elements of the SCM application through configurable components. The SCM application user or end user triggers and interacts with the customization layer 105 for execution of the operation through application user machine 106, a function developer user or citizen developer user triggers and interacts with the application layer 104 to develop the SCM application for execution of the operation through citizen developer machine 106A, and a platform developer user through its computing device 106B triggers the shared framework layer 103, the foundation layer 102 and the data layer 101 to structure the platform for enabling codeless development of SCM applications.

In an embodiment the present invention provides one or more SCM enterprise application with an end user application UI and a citizen developer user application UI for structuring the interface to carry out the required operations.

The layered platform architecture reduces complexity as the layers are built one upon another thereby providing high levels of abstraction, making it extremely easy to build complex features for the SCM application. However, one or more applications developed through the platform architecture requires reconfiguration of task management in the application. Since the functions are added or removed or modified by the developer seamlessly, the reconfiguration of the system to manage the related changes in the task is cumbersome.

In one embodiment, the architecture 100 provides the cloud agnostic data layer 101 as a bottom layer of the architecture. This layer provides a set of micro-services that collectively enable discovery, lookup and matching of storage capabilities to needs for execution of operational requirement. The layer enables routing of requests to the appropriate storage adaptation, translation of any requests to a format understandable to the underlying storage engine (relational, key-value, document, graph, etc.). Further, the layer manages connection pooling and communication with the underlying storage provider and automatically scales and de-scaling the underlying storage infrastructure to support operational growth demands.

In one example embodiment, Key-Value stores data abstraction of the data layer provides extremely fast lookup and update of values based on a certain key. The underlying hash implementation provides for extremely fast lookups and updates. Because the keys can be partitioned easily, the systems grow horizontally instead of vertically, making resolution of the scaling problem a lot easier. The data abstraction of the present invention provides for Cloud agnostic solutions.

In yet another example embodiment, a Graph data stores data abstraction of the data layer excel in maintaining relationships across documents and navigating across documents through relationships in a blazingly fast manner. Nodes in the graph (think documents or references to documents) can be partitioned easily, making it conducive to building horizontally scalable systems.

In an example embodiment, a document data stores data abstraction of the data layer store all attributes of a document as a single record, much like a relational database system. The data is usually denormalized in these document stores, making data joins common in traditional relational systems unnecessary. Data joins (or even complex queries) can be expensive with this data store, as they typically require map/reduce operations which don't lend themselves well in transactional systems (OLTP-online transactional processing).

In another example embodiment, a relational data abstraction of the data layer allows for data to be sliced and analyzed in an extremely flexible manner.

In a related embodiment, the plurality of configurable components includes one or more data layer configurable components including but not limited to Query builder, graph database parser, data service connector, transaction handler, document structure parser, event store parser and tenant access manager. The data layer provides abstracted layers to the SCM service to perform data operations like Query, insert, update, delete and Join on various types of data stores document database (DB) structure, relational structure, key value structure and hierarchical structure.

The memory data store/data lake of the data layer/storage platform layer may be a volatile, a non-volatile memory or memory may also be another form of computer-readable medium, such as a magnetic or optical disk. The memory store may also include storage device capable of providing mass storage. In one implementation, the storage device may be or contain a computer-readable medium, such as a floppy disk device, a hard disk device, an optical disk device, or a tape device, a flash memory or other similar solid-state memory device, or an array of devices, including devices in a storage area network or other configurations.

In an embodiment the platform architecture provides the foundation layer 102 on top of the data layer 101 of the architecture 100. This layer provides a set of microservices that execute the tasks of managing code deployment, supporting code versioning, deployment (gradual roll out of new code) etc. The layer collectively enables creation and management of smart forms (and templates), framework to define UI screens, controls etc. through use of templates. Seamless theming support is built to enable specific form instances (created at runtime) to have personalized themes, extensive customization of the user experience (UX) for each client entity and or document. The layer enables creation, storage and management of code plug-ins (along with versioning support). The layer includes microservice and libraries that enable traffic management of transactional document data (by client entity, by document, by template, etc.) to the data layer 101, enables logging and deep call-trace instrumentation, support for request throttling, circuit breaker retry support and similar functions. Another set of microservice enables service to service API authentication support, so API calls are always secured. The foundation layer micro services enable provisioning (on boarding new client entity and documents), deployment and scaling of necessary infrastructure to support multi-tenant use of the platform. The set of microservices of foundation layer are the only way any higher layer microservice can talk to the data layer microservices. Further, machine learning techniques auto-scale the platforms to optimize costs and recommend deployment options for entity such as switching to other cloud vendors etc.

In an exemplary embodiment, the data layer 101 and foundation layer 102 of the architecture 100 function independent of the knowledge of the operation. Since, the platform architecture builds certain configurable component as independent of the operation in the application, they are easily modifiable and restructured.

In a related embodiment, the plurality of configurable components includes one or more foundation layer configurable components including but not limited to logger, Exception Manager, Configurator Caching, Communication Layer, Event Broker, Infra configuration, Email Sender, SMS Notification, Push notification, Authentication component, Office document Manager, Image Processing Manager, PDF Processing Manager, UI Routing, UI Channel Service, UI Plugin injector, Timer Service, Event handler, and Compare service for managing infrastructure and libraries to connect with cloud computing service.

In an embodiment, the platform architecture provides the shared framework layer 103 on top of the foundation layer 102. This layer provides a set of microservices that collectively enable authentication (identity verification) and authorization (permissioning) services. The layer supports cross-document and common functions such as rule engine, workflow management, document approval (built likely on top of the workflow management service), queue management, notification management, one-to-many and many-to-one cross-document creation/management, etc. The layer enables creation and management of schemas (aka documents), and support orchestration services to provide distributed transaction management (across documents). The service orchestration understands different document types, hierarchy and chaining of the documents etc.

The shared framework layer 103 has the notion of our operational or application domains, the set of microservices that contribute this layer hosts all the common functionality so individual documents (implemented at the application layer 104) do not have to repeatedly to the same work. In addition to avoiding the reinventing the wheel separately by each developer team, this layer of microservices standardizes the capabilities so there is no loss of features at the document level, be it adding an attribute (that applies to a set of documents), supporting complex approval workflows, etc. The rule engine along with tools to manage rules is part of this layer.

In an exemplary embodiment, the shared framework layer 103 supports the notion of entity/client and documents. The layer captures a set of metadata about the entity/client (where data should be stored, the disaster recovery plans/options, data security standards-encryption, etc., geographical data restrictions by document type) to auto-setup the entity specific infrastructure in an ongoing manner. The set of metadata about the documents (what type of document, what capabilities are needed-approvals, notifications, etc., what interactions are needed with other documents) are also captured by the layer. Generic capability support provided by this layer of microservices is automatically enabled based on this metadata. Further, to ensure all future documents auto-inherit all current and future generic capabilities this layer supports, all documents and microservices from the next applications layer will only go through this layer. When this layer does not provide any value-add, the calls will go through a simple pass through layer of microservices.

In a related embodiment, the plurality of configurable components includes one or more shared framework configurable components including but not limited to license manager, Esign service, application marketplace service, Item Master Data Component, organization and accounting structure data component, master data, Import and Export component, Tree Component, Rule Engine, Workflow Engine, Expression Engine, Notification, Scheduler, Event Manager, and version service.

In one embodiment, the architecture 100 provides the application layer 104 on top of the shared framework layer 103 of the architecture. The developer user of the platform will interact with the application layer 103 for structuring the SCM application. This is also the first layer, that defines SCM specific documents such as requisitions, contracts, orders, invoices etc. This layer provides a set of microservices to support creation of documents (requisition, order, invoice, etc.), support the interaction of the documents with other documents (ex: invoice matching, budget amortization, etc.) and provide differentiated operational/functional value for the documents in comparison to a competition by using artificial intelligence and machine learning. This layer also enables execution of complex operational/functional use cases involving the documents.

In an exemplary embodiment, a developer user or admin user will structure one or more SCM application and associated functionality by the application layer of microservices, either by leveraging the shared frameworks platform layer or through code to enable the notion of specific documents or through building complex functionality by intermingling shared frameworks platform capabilities with custom code. Besides passing on the entity metadata to the shared frameworks layer, this set of microservices do not carry any concern about where or how data is stored. Data modeling is done through template definitions and API calls to the shared frameworks platform layer. This enables this layer to primarily and solely focus on adding operational/functional value without worrying about infrastructure.

Further, in an advantageous aspect, all functionality or application services built at the application layer are exposed through an object model, so higher levels of orchestrations of all these functionalities is possible to build by custom implementations for end users. The platform will stay pristine and clean and be generic, while at the same time, enables truly custom features to be built in a lightweight and agile manner. The system of the invention is configured to adapt to the changes in the application due to the custom features and operate the application to manage one or more tasks to be executed.

In an embodiment, the architecture 100 provides the customization layer 105 as the topmost layer of the architecture above the application layer 104. This layer provides microservices enabling end users to write codes to customize the operational flows as well as the end user application UI to execute the operations of SCM. The end user can orchestrate the objects exposed by the application layer 104 to build custom functionality, to enable nuanced and complex workflows that are specific to the end user operational requirement or a third-party implementation user.

In a related embodiment, the plurality of configurable components includes one or more customization layer configurable components including but not limited to a plurality of rule engine components, configurable logic component, component for structuring SCM application UI, Layout Manager, Form Generator, Expression Builder Component, Field & Metadata Manager, store-manager, Internationalization Component, Theme Selector Component, Notification Component, Workflow Configurator, Custom Field Component & Manager, Dashboard Manager, Code Generator and Extender, Notification, Scheduler, form Template manager, State and Action configurator for structuring the one or more SCM application to execute at least one SCM application operation.

In an exemplary embodiment, each of these layers of the platform architecture communicates or interacts only to the layer directly below and never bypasses the layers through operational workflow thereby enabling highly productive execution with secured interaction through the architecture.

Depending on the type of user the user interface (UI) of the application user machine 106 is structured by the platform architecture. The application user machine 106 with a application user UI is configured for sending, receiving, modifying or triggering processes and data object for operating one or more of a SCM application over a network 107.

The computing devices referred to as the entity machine, server, processor etc. of the present invention are intended to represent various forms of digital computers, such as laptops, desktops, workstations, personal digital assistants, and other appropriate computers. Computing device of the present invention further intend to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this disclosure.

The system includes a server 108 configured to receive data and instructions from the application user machines 106. The system 100 includes a support mechanism for performing various prediction through AI engine and mitigation processes with multiple functions including historical dataset extraction, classification of historical datasets, artificial intelligence based processing of new datasets and structuring of data attributes for analysis of data, creation of one or more data models configured to process different parameters.

In an embodiment, the system is provided in a cloud or cloud-based computing environment. The codeless development system enables more secured processes.

In an embodiment the server 108 of the invention may include various sub-servers for communicating and processing data across the network. The sub-servers include but are not limited to content management server, application server, directory server, database server, mobile information server and real-time communication server.

In example embodiment the server 108 shall include electronic circuitry for enabling execution of various steps by processor. The electronic circuitry has various elements including but not limited to a plurality of arithmetic logic units (ALU) and floating-point Units (FPU's). The ALU enables processing of binary integers to assist in formation of at least one table of data attributes where the data models implemented for dataset characteristic prediction are applied to the data table for obtaining prediction data and recommending action for codeless development of SCM applications. In an example embodiment the server electronic circuitry includes at least one Athematic logic unit (ALU), floating point units (FPU), other processors, memory, storage devices, high-speed interfaces connected through buses for connecting to memory and high-speed expansion ports, and a low speed interface connecting to low speed bus and storage device. Each of the components of the electronic circuitry, are interconnected using various busses, and may be mounted on a common motherboard or in other manners as appropriate. The processor can process instructions for execution within the server 108, including instructions stored in the memory or on the storage devices to display graphical information for a graphical user interface (GUI) on an external input/output device, such as display coupled to high speed interface. In other implementations, multiple processors and/or multiple busses may be used, as appropriate, along with multiple memories and types of memory. Also, multiple servers may be connected, with each server providing portions of the necessary operations (e.g., as a server bank, a group of blade servers, or a multi-processor system).

The processor may be implemented as a chipset of chips that include separate and multiple analog and digital processors. The processor may provide coordination of the other components, such as controlling user interfaces, applications run by devices, and wireless communication by devices. The Processor may communicate with a user through control interface and display interface coupled to a display. The display may be, for example, a TFT LCD (Thin-Film-Transistor Liquid Crystal Display) or an OLED (Organic Light Emitting Diode) display, or other appropriate display technology. The display interface may comprise appropriate circuitry for driving the display to present graphical and other information to an entity/user. The control interface may receive commands from a user/demand planner and convert them for submission to the processor. In addition, an external interface may be provided in communication with processor, so as to enable near area communication of device with other devices. External interface may provide, for example, for wired communication in some implementations, or for wireless communication in other implementations, and multiple interfaces may also be used.

In an example embodiment, the system of the present invention includes a front-end web server communicatively coupled to at least one database server, where the front-end web server is configured to process the dataset characteristic data based on one or more data models and applying an AI based dynamic processing logic to automate prioritization of task in the application developed by the codeless development actions through process orchestrator.

In an embodiment, the platform architecture 100 of the invention includes a process orchestrator 109 configured for enabling interaction of the plurality of configurable components in the layered architecture 100 for executing at least one SCM application operation and development of the one or more SCM application. The process orchestrator 109 includes plurality of components including an application programming interface (API) for providing access to configuration and workflow operations of SCM application operations, an Orchestrator manager configured for Orchestration and control of SCM application operations, an orchestrator UI/cockpit for monitoring and providing visibility across transactions in SCM operations and an AI based process orchestration engine configured for interacting with a plurality of configurable components in the platform architecture for executing SCM operations.

In an embodiment, the process orchestrator includes a blockchain connector for integrating blockchain services with the one or more SCM application and interaction with one or more configurable components. Further, Configurator User interface (UI) services are used to include third party networks managed by domain providers.

In a related aspect, the Artificial intelligence (AI) based orchestrator engine coupled to a processor execute SCM operation by at least one data model wherein the AI engine transfers processed data to the UI for visibility, exposes SCM operations through API and assist the manager for orchestration and control.

In an embodiment, the present invention uses GPUs (Graphical processing units) for enabling AI engine to provide computing power to processes humongous amount of data.

In an exemplary embodiment, the AI engine employs machine learning techniques that learn patterns and generate insights from the data for enabling the process orchestrator to automate operations. Further, the AI engine with ML employs deep learning that utilizes artificial neural networks to mimic biological neural network in human brains. The artificial neural networks analyze data to determine associations and provide meaning to unidentified or new dataset.

In another embodiment, the invention enables integration of Application Programming Interfaces (APIs) for plugging aspects of AI into the dataset characteristic prediction and operations execution for operating one or more SCM enterprise application.

In an embodiment, the system 100 of the present invention includes a workflow engine that enables monitoring of workflow across the SCM applications. The workflow engine with the Process orchestrator enables the platform architecture to create multiple approval workflows. The task assigned to a user is prioritized through the AI based data processing system based on real time information.

In an embodiment the machine 106 may communicate with the server 108 wirelessly through communication interface, which may include digital signal processing circuitry. Also, the machine (106) may be implemented in a number of different forms, for example, as a smartphone, computer, personal digital assistant, or other similar devices.

In an exemplary embodiment, the developer application user interface (UI) and the application user interface of the machines 106 enables cognitive computing to improve interaction between user and an enterprise or supply chain application(s). The interface improves the ability of a user to use the computer machine itself. Since, the interface triggers configurable components of the platform architecture for structuring an SCM application to execute at least one operation including but not limited to creation of Purchase order, Contract lifecycle management operations, Warehouse management operations, inventory management operations etc., at the same instant, the interface thereby enables a user to take informed decision or undertake an appropriate strategy for adjusting workflow for execution of operations. By structuring operations and application functions through a layered platform architecture and eliminating multiple cross function layers, repetitive processing tasks and recordation of information to get a desired data or operational functionality, which would be slow and complex the user interface is more user friendly and improves the functioning of the existing computer systems.

Referring to FIG. 1, the system 100 further includes application/document module 110 having invoice, inventory, RFX, Order, Contract, ASN, Supplier, User components along with master data and approval flows. The system includes at least one identification bot/sniffer 111 for identifying at least one relevant data from the application data.

In a related embodiment, the system 100 of the invention provides a task management module 112 having transaction analyzer, transaction capture, customer analyzer and field analyzer along with task generator and UI dashboard as components of the module 112. Further, the system 100 includes notification service 113 and channel 114 for mail, in application, SMS and push notification service.

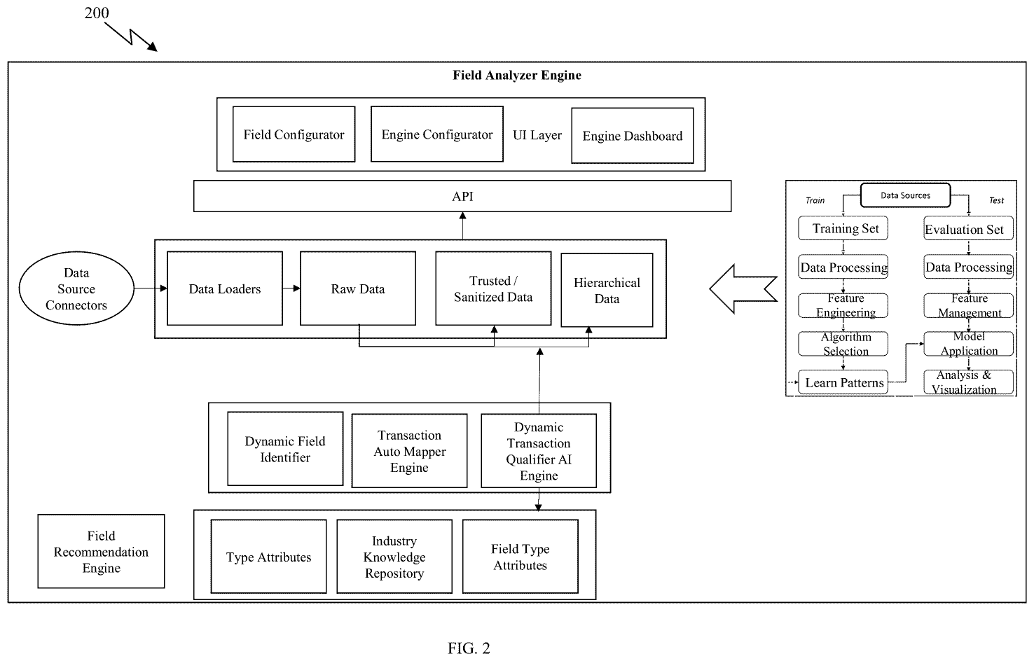

Referring to FIG. 2, a block diagram of a field analyzer engine is shown in accordance with an embodiment of the invention. The Field Analyzer engine is responsible for identifying dynamic fields generated through low code platform. Using historical data, industry knowledge repository new fields are classified based on data type, relationships, synonyms and related attributes are used to identify the type of fields and impact in the system etc.

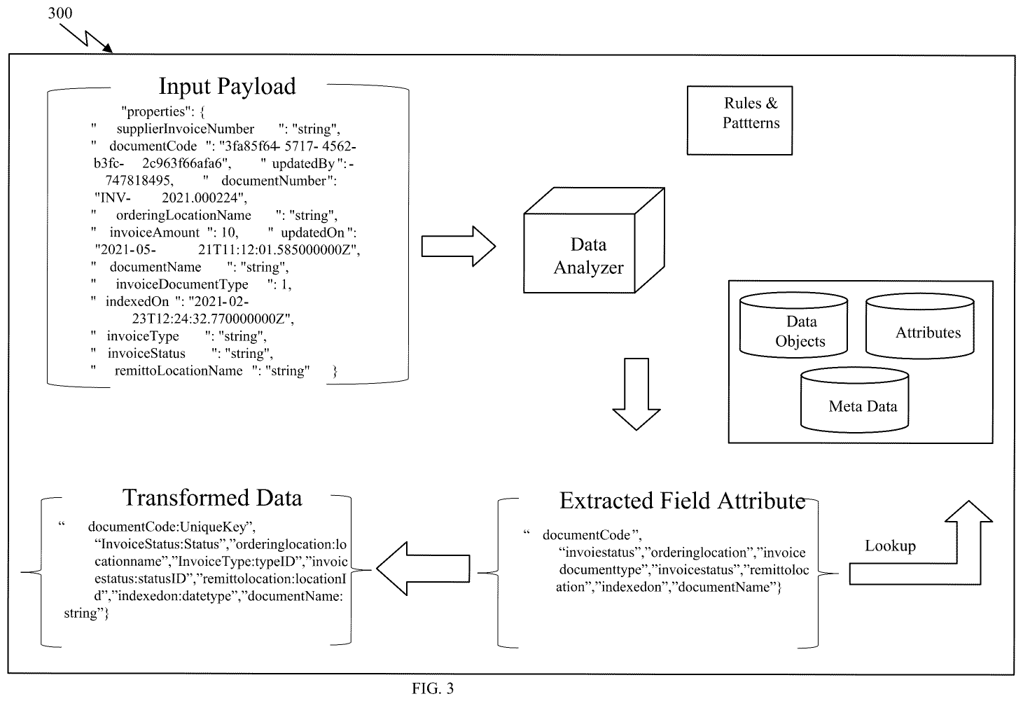

Referring to FIG. 3, a flow diagram 300 depicting the data analyzer of the data processing system is shown in accordance with an embodiment of the invention. The data analyzer configured to link the processed one or more data attribute to one or more data elements and assigning an identifier to the data object associated with the data attribute before storing in the historical data elements database. The data analyzer receives input payload and extract field/data attributes from the one or more data objects before transforming the extracted attributes. Data Analyzer is an in-memory engine running on multi node servers. Engine refers to predefined rules configured for enabling the processor to process data for analysis. The rules are composed of JSON structures, allowing it easy to configure and human readable. The data analyzer receives payload in JSON format. Using JSON rule, extracts data attributes and data elements (including content, value) from data objects. Using Rule Patterns, synonyms lookup, industry terminology recognizer and historical lookup from data objects, attributes and Metadata identifies data attributes from Payload. The data analyzer transforms and creates JSON structure for network relation.

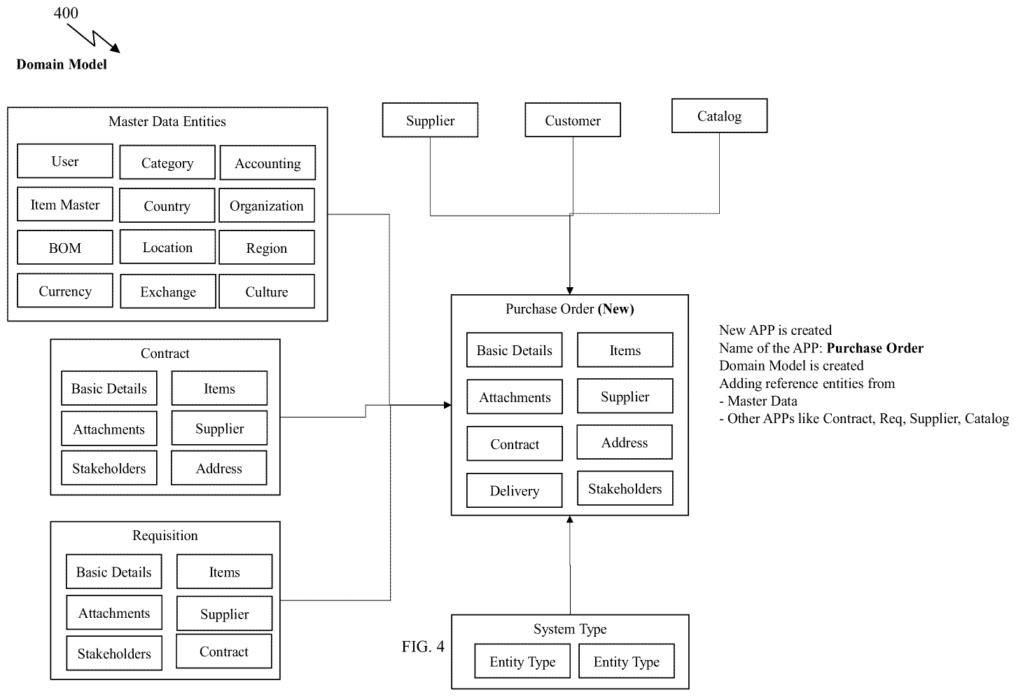

Referring to FIG. 4, is a domain model structure 400 of the data processing system in accordance with an embodiment of the invention. The domain model structure is a building block of enterprise codeless Platform. It is a core layer of the architecture used as a communication channel between components across layers. The domain model is a representation of enterprise codeless platform independent of the way data is stored in databases. Domain model enforces standardization with respect to schema, nomenclature, validations across supply chain applications. The domain model describes the domain types for an enterprise with their constraints. Using domain data types instead of base data types ensures consistency across an enterprise and allows reuse of common data type definitions for greater efficiency.

Domain entities represent classes of real-world objects. They have properties that identify or describe them. Entity properties also govern their availability and behavior related to the application's visual elements or business logic. Entities may have event handlers which describe the behavior of the entity before/after committing the runtime transaction of a specific entity.

Entities includes Persistable entity, meaning that they represent a schema in the data service, Non-Persistable entity, meaning that they are used in context of integration, as a reference for example to master data and are not represented directly with a schema definition in the data service. Entities are used to define DAC for users consuming data from a specific application. Entities are imported and/or exported from a domain model under the form of a canonical structure, or even any JSON structure.

The data processing system of the invention enables processing of tasks even when new applications are created. For eg: When Purchase order is created, the domain model is created by adding reference entities from master data and other applications like Contract, Req, Supplier, Catalog etc., as shown in the domain model structure 400 of the FIG. 4.

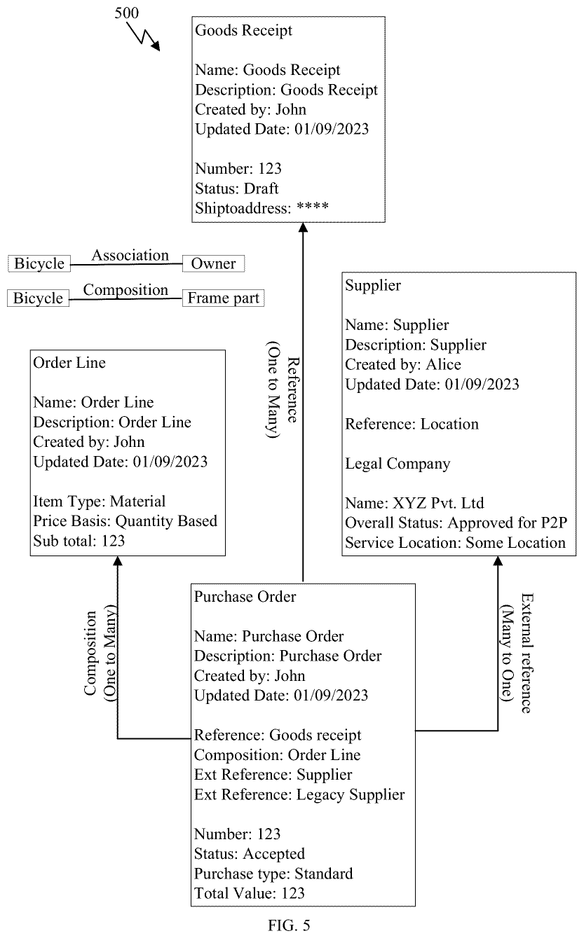

Referring to FIG. 5, is a process flow diagram 500 of task management system in accordance with an embodiment of the invention. The flow diagram 500 shows the data attributes associated with various applications including Order line, PO, Goods receipt and Supplier details etc. The flow diagram provides the type of association between applications and entities. The associations between entities are critical to effective modeling as without them, the model is just a vocabulary of broad terms since it lacks the “collaborative” context. They can be used to create more complex structures, by referencing or composing entities. The types of association may include: a) Reference-both entities can exist independently and still have business value. Example: Order→Supplier; b) Composition—a particular type of entity association, modeling a “part-of-a-whole” relationship between the composite and a group of parts. The items (data records) of composed entities are bound, so deleting the “whole” would also delete the “parts”. Example: Order→Order Schedule.

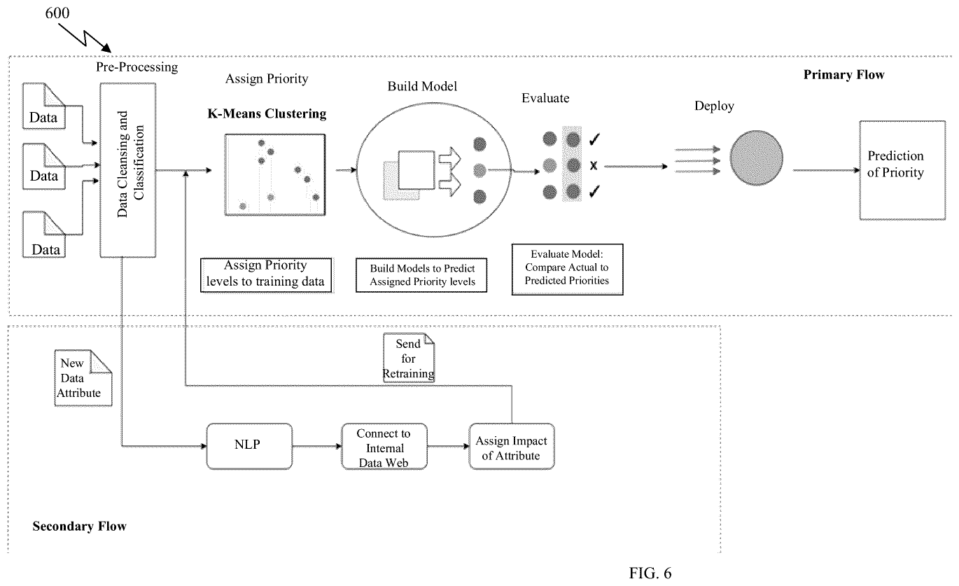

Referring to FIG. 6, a flow diagram 600 depicting determination of task priority in accordance with an example embodiment of the invention. In one aspect, the task priority is determined with a primary flow. As an example embodiment, the primary flow with data attributes of a contract object for data cleansing is provided as:

{ ″_id″: ″60eac05f-8971-4706-9a4a-553d3a9ba841″, ″id″: ″28b539dc-be9f-48e4-b000-
5ff37df465d5″, ″name″: ″Milestone 1″, ″description″: ″Milestone 1 Description″, ″criticality″: {
″culture″: ″en-US″, ″version″: ″1″, ″id″: ″1″, ″name″: ″Low″, ″code″: ″1″ }, ″isActive″:
true, ″isDeleted″: false, ″isMandatory″: true, ″milestoneDueDate″: { ″$date″: {
″$numberLong″: ″1/1/2022″ } }, ″isApprovalRequired″: true, ″isGroupAssigned″: true,
″assignee″: { ″contactCode″: { ″$numberLong″: ″1972500040000001″ }, ″emailId″:
″admin@gep.com″, ″firstName″: ″ADMIN″, ″fullName″: ″ADMIN USER″, ″lastName″:
″USER″ } ″milestoneApprovers″: [ { ″id″: 0, ″name″: null, ″contactCode″: {
″$numberLong″: ″1972500040000001″ }, ″emailId″: ″admin@gep.com″, ″firstName″: ″
ADMIN″, ″fullName″: ″ ADMIN USER″, ″lastName″: ″USER″ } ], ″_schemaver″: ″1″,
″bpc″: 197250, ″updatedTimeStamp″: { ″$date″: { ″$numberLong″: ″1631183114009″ }
}, ″createdBy″: ″1972500040000001″, ″createdOn″: {″$date″: {″$numberLong″:
″1631184434990″} }, ″updatedBy″: ″ ADMIN USER″, ″updatedOn″: {″$date″: {
″$numberLong″: ″1635158458319″ } }, ″location″: ″IN-MH″, ″createdByContactCode″: null,
″updatedByContactCode″: ″1972500040000001″}

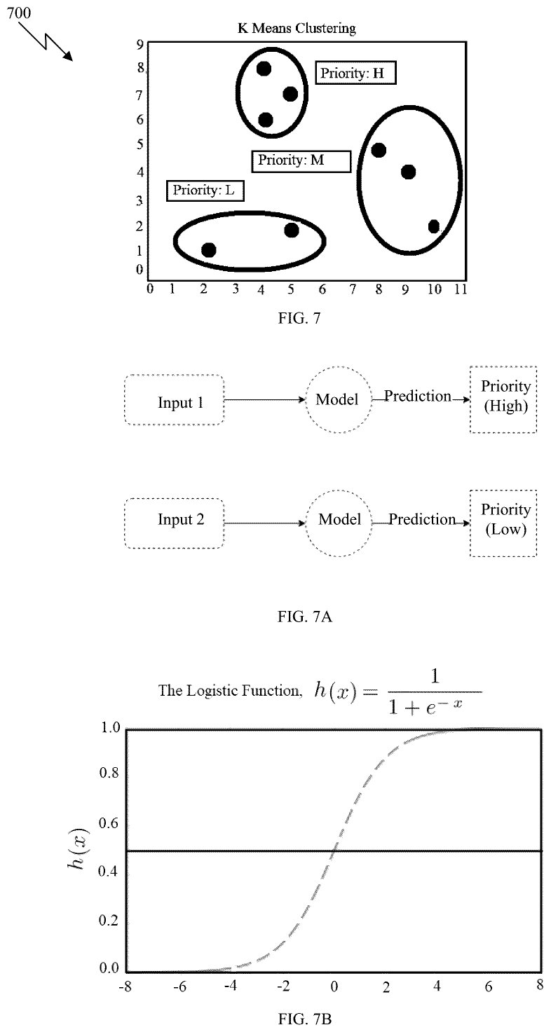

Once the data is cleansed, the data clustering is performed. After preprocessing, structured, and unstructured dataset are joined at ticket or issue ID to create data inputs for a clustering algorithm such as K-Means Clustering as shown by clustering map 700 in FIG. 7. The Clustering algorithm groups data points together by figuring out the underlying patterns and hidden relationships between them. The output of K-Means consists of cluster labels for each observation (cluster #1, cluster #2, etc.). Clusters are then converted into priority levels (low, medium, high, etc.) using business domain knowledge.

In a related embodiment, K-Means works by grouping data into K groups. K is either fixed in advance or optimized using the Elbow Method. The Elbow Method selects the number of clusters. This maximizes the similarity between data points within each cluster without creating more clusters than required. Total variation within clusters is graphed and the elbow point is identified as the optimal number of clusters.

K-Means helps us figure out priority levels for the input data (tickets). Priorities are used as target variable Y in building an online model from input feature set X. Thus, the problem is translated from unsupervised learning to a multi-class classification problem.

Referring to FIG. 7A, a block diagram 700A of data model evaluation and deployment is shown in accordance with an example embodiment of the invention. The trained model is evaluated against test data and ticket data that was not used in building it. Test data is fed into the model and priority levels are received at the Output. These priorities are compared against the test data's actual priority levels as determined by K-Means. If the model evaluation is satisfactory, then it is deployed. The online model generalizes to unseen data by updating results in near real-time, and then displays a priority level for the new ticket or issue.

Logistic regression is best suited for this scenario: data sets where y=0 or 1, where 1 denotes the default class. For example, in predicting whether an event is high priority or low priority, there are only two possibilities: that it occurs (which we denote as 1) or that it does not (0). So, if the system is predicting whether a task is high priority, the system may label that task using the value of 1 in the data set. Logistic regression is named after the transformation function it uses, which is called the logistic function h(x)=1/(1+ex). This forms an S-shaped curve.

In logistic regression, the output takes the form of probabilities of the default class (unlike linear regression, where the output is directly produced). Since it is a probability, the output lies in the range of 0-1. So, for example, if system is trying to predict whether a task is a high priority, the reference is already known that high priority tasks are denoted as 1, so if the system algorithm assigns the score of 0.98 to a task, it thinks that the task is quite likely to be high priority.

This output (y-value) is generated by log transforming the x-value, using the logistic function h(x)=1/(1+e\hat{ }−x) as shown in graph 700B of FIG. 7B. A threshold is then applied to force this probability into a binary classification. The input to this function (x) would be the task/transaction. Output would be a 0 or 1 depicting low or high priority. Once the model evaluation is completed it is deployed vis CICD pipelines.

In another aspect, the task priority is determined with a Secondary flow as shown in FIG. 6. The secondary flow contains the scenario where our app receives an unknown on untrained variable/attribute in the input object. The objective of this secondary flow is to obtain useful info from the new attribute à compare and use logic to do conflict resolution à assign weightage to attribute based on past data and usage within GEP system à re-train model with new weightage of attribute. As an example embodiment, the secondary flow with data attributes of a contract object is provided as:

{ ″_id″: ″60eac05f-8971-4706-9a4a-553d3a9ba841″, ″id″: ″28b539dc-be9f-48e4-b000-
5ff37df465d5″, ″name″: ″Milestone 1″, ″description″: ″Milestone 1 Description″, ″criticality″: {
″culture″: ″en-US″, ″version″: ″1″, ″id″: ″1″, ″name″: ″Low″, ″code″: ″1″ }, ″isActive″:
true, ″isDeleted″: false, ″isMandatory″: true, ″milestoneDueDate″: { ″$date″: {
″$numberLong″: ″1/1/2022″ } }, ″isApprovalRequired″: true, ″isGroupAssigned″: true,
″assignee″: { ″contactCode″: { ″$numberLong″: ″1972500040000001″ }, ″emailId″:
″admin@gep.com″, ″firstName″: ″ADMIN″, ″fullName″: ″ADMIN USER″, ″lastName″:
″USER″ } ″milestoneApprovers″: [ { ″id″: 0, ″name″: null, ″contactCode″: {
″$numberLong″: ″1972500040000001″ }, ″emailId″: ″admin@gep.com″, ″firstName″: ″
ADMIN″, ″fullName″: ″ ADMIN USER″, ″lastName″: ″USER″ } ], ″_schemaver″: ″1″,
″bpc″: 197250, ″updatedTimeStamp″: { ″$date″: { ″$numberLong″: ″1631183114009″ }
}, ″createdBy″: ″1972500040000001″, ″createdOn″: {″$date″: { ″$numberLong″:
″1631184434990″ } }, ″updatedBy″: ″ ADMIN USER″, ″updatedOn″: { ″$date″: {
″$numberLong″: ″1635158458319″ } }, ″location″: ″IN-MH″, ″createdByContactCode″: null,
″updatedByContactCode″: ″1972500040000001″ Contractvalue:″4000″,
″ExternalAudit_date″:″12/31/2022″,″Comments″:″This is a priority task″}.

In a related embodiment, the invention deploys NLP technique to synthesize and understand the new attributes and connect with the data network to determine the impact of the new data attributes. Based on the impact, the attribute is fed back to the primary model for retraining.

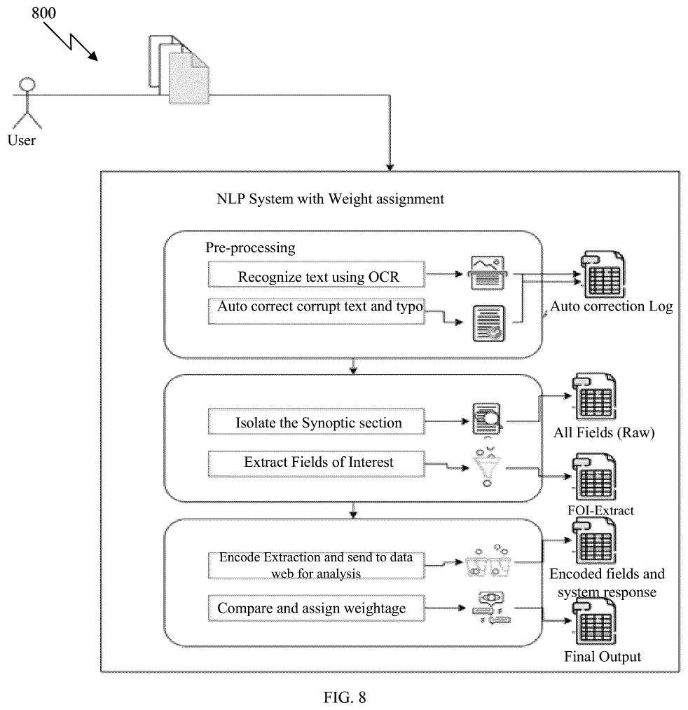

In an example embodiment, the NLP technique with data attribute weight assignment is shown in block diagram 800 of FIG. 8. The NLP Code for synthesizing includes initialization method with multiple layers for the network. For, the data attribute weights assignment Code initially all attributes are assigned a weight of 5 on the scale of 1-10. Then, a graph is plotted with all these weights with Time Index as X-axis. The codes include:

```
#Importing Libraries
import numpy as np
import matplotlib.pyplot as plt
import pandas as pd
#Importing the data set
dataset = pd.read_csv(′System.csv′).fillna(′ ′)
#Extracting all the error logs from the dataset.
Error_Index = [ ]
for i in range(0,len(dataset)):
  if(dataset[′EntryType′][i] == ″Error″):
    Error_Index.append(i)
Error_Data = dataset.iloc[Error_Index, :]
Index = list(range(len(Error_Index)))
Error_Data = Error_Data.set_index(pd.Index(Index))
Error_Data[′Weight′] = Error_Data.apply(lambda row: 0, axis =1)
Weight = Error_Data.iloc[:, 16]
def time_diff(t1, t2): #Function, which returns difference between
two times
  if(t1[0:10] == t2[0:10]):
    a = int(t1[11:13])*60 + int(t1[14:16])
    b = int(t2[11:13])*60 + int(t2[14:16])
    return abs(b-a)
  elif(t1[11:13] == ′23′ and t2[11:13] == ′00′):
    a = 1380 + int(t1[14:16])
    b = 1440 + int(t2[14:16])
    return abs(b-a)
  else:
    return 31
Log_Time = { } #Dictionary for storing the time of event occurrence.
Log_Freq = { } #Dictionary for storing the frequency of occurrence
within 30 mins.
for i in range(0,len(Error_Data)):
  row = len(Error_Data)-i-1
  if(Error_Data[′EventID′][row] in Log_Time):
    k = time_diff(Log_Time[Error_Data[′EventID′][row]],
Error_Data[′TimeGenerated′][row])
    if(k <= 30):
      if(Log_Freq[Error_Data[′EventID′][row]] == 1):
        Weight[row] = 10
        Log_Time[Error_Data[′EventID′][row]] = Error_Data
        [′TimeGenerated′][row]
      else:
        Weight[row] = 8
        Log_Freq[Error_Data[′EventID′][row]] = 1
        Log_Time[Error_Data[′EventID′][row]] = Error_Data
        [′TimeGenerated′][row]
    else:
      Weight[row] = 5
      Log_Freq[Error_Data[′EventID′][row]] = 0
      Log_Time[Error_Data[′EventID′][row]] = Error_Data
      [′TimeGenerated′][row]
  else:
    Weight[row] = 5
    Log_Freq[Error_Data[′EventID′][row]] = 0
    Log_Time[Error_Data[′EventID′][row]] = Error_Data
    [′TimeGenerated′][row]
#Plotting the graph with weights as Y-axis and Time Index as X-axis
Index.reverse( )
plt.scatter(Index, Weight, color = ′blue′)
plt.plot(Index, Weight, color = ′green′)
Y = 9
plt.hlines(Y, xmin = 0, xmax = 400, color = ′red′)
Y = 7
plt.hlines(Y, xmin = 0, xmax = 400, color = ′yellow′)
plt.title(′Error Occurence′)
plt.xlabel(′Time Index′)
plt.ylabel(′Error Value′)
plt.ylim(0, 11)
```

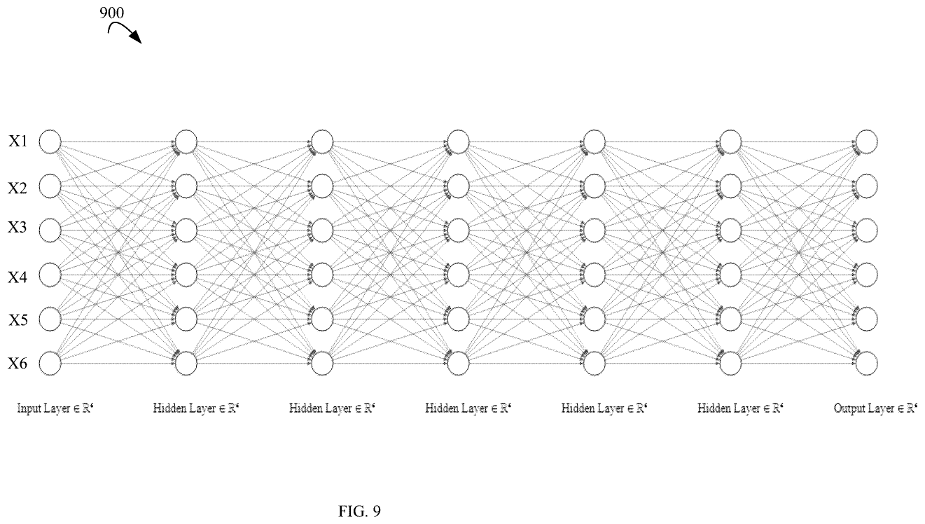

In an example embodiment, the output is to understand the kind of data source and how it is connected to data network for feeding to the classification script. The output Neural network 900 is shown in FIG. 9.

{″_id″:″9098e629-4c9a-4e8b-84e4-5dc42d74d286″,″id″:″e9a2310e-11le-4c7c-ae0c-
7e3e2d6b6374″,″documentId″:″cbe0dbd9-449e-410a-8711-
96edcb5d4f4d″,″bucketId″:″f83eab0f-363d-4758-bbd9-f16e6f35f454″,″title″:″c2e3ed7e-a580-
4082-b62e-a291b648ae91″,″attributes″:[{″key″:″Event Name″,″value″:null},{″key″:″Event
Number″,″value″:null},{″key″:″Status″,″value″:″EventWithdrawnRejected″},{″key″:″Created
By″,″value″:null},{″key″:″Created On″,″value″:null },{″key″:″Last Modified
On″,″value″:null}],″createdDate″:{″$date″:″2021-12-
22T14:29:14.159Z″},″createdBy″:″89826″,″updatedDate″:{″$date″:″2021-12-
22T14:30:37.131Z″},″updatedBy″:″479064″,
,″documentGroupSubObjectActionCode″:″PendingApproval″,″documentGroupCode″:″RFx″,″ap
provalId″:″00000000-0000-0000-0000-
000000000000″,″actions″:null,″assignTo″:[{″assigneeId″:″1972500040000279″,″stateId″:2},{″a
ssigneeId″:″0040000280″,″stateId″:1}],″documentStatus″:″Pending″,″_schemaver″:″1″,″isActive
″: true,″location″:″IN-sMH″}

Suppose the input is X with n components and a linear neuron with random weights W that spits out an output Y. The variance of y can be written as:

$$Y = {W}_{1} {X}_{1} + {W}_{2} {X}_{2} + … + {W}_{n} {X}_{n}$$

The variance of WᵢXᵢ is

$$Var ( {W}_{i} {X}_{i} ) = {E ( {X}_{i} )}_{2} Var ( {W}_{i} ) + {E ( {W}_{i} )}_{2} Var ( {X}_{i} ) + Var ( {W}_{i} ) Var ( {X}_{i} ) Var ( {W}_{i} {X}_{i} )$$

Here, assume that Xi and Wi are all identically and independently distributed (Gaussian distribution with zero mean), then the variance of Y is:

$$\begin{matrix}Var ( Y ) = Var ( W 1 X 1 + W 2 X 2 + … + WnXn ) \\ = Var ( W 1 X 1 ) + Var ( W 2 X 2 ) + … + Var ( WnXn ) \\ = n Var ( Wi ) Var ( Xi ) Var ( Y )\end{matrix}$$

The variance of the output is the variance of the input but it is scaled by nVar(Wi). Hence, if we want the variance of Y to be equal to the variance of XX, then the term nVar(Wi) should be equal to 1. Hence, the variance of the weight should be:

$$Var ( {W}_{i} ) = 1 / n = 1 / {n}_{i n}$$

This is Xavier Initialization formula. We need to pick the weights from a Gaussian distribution with zero mean and a variance of 1/nᵢₙ where nᵢₙ is the number of input neurons in the weight tensor. That is how Xavier (Glorot) initialization is implemented in Caffee library.
Similarly, if we go through backpropagation, we apply the same steps and get:

$$Var ( {W}_{i} ) = 1 / {n}_{o u t}$$

In order to keep the variance of the input and the output gradient the same, these two constraints can only be satisfied simultaneously if nᵢₙ=nₒᵤₜ However, in the general case, the nᵢₙ and nₒᵤₜ of a layer may not be equal, and so as a sort of compromise, Glorot and Bengio suggest using the average of the nᵢₙ and nₒᵤₜ, proposing that:

$$Var ( {W}_{i} ) = 1 / {n}_{avg}$$

where n_{avg}=nᵢₙ+nₒᵤₜ/2.
So, the idea is to initialize weights from Gaussian Distribution with mean=0.0 and variance:

$$σ = √ 2 / √ ( {n}_{i n} + {n}_{out} )$$

Note that when the number of input connections is roughly equal to the number of output connections, you get the simpler equations:

$$σ2 = 1 / {n}_{i n}$$

The output of the above is the neural network 900 of size as shown in FIG. 9.

In an exemplary embodiment, the data processing system and method of the present invention utilizes service level agreement (SLA) based approach to find out shortest time taken. The system is configured to find the shortest paths from the source vertex to all other vertices in the graph. The method includes the steps of setting all vertices distances to infinity except for the source vertex, and setting the source distance to 0. Then pushing the source vertex in a min-priority queue in the form (distance, vertex), as the comparison in the min-priority queue will be according to vertices distances. Further, popping the vertex with the minimum distance from the priority queue (at first the popped vertex is equal to source). Then, updating the distances of the connected vertices to the popped vertex in case of “current vertex distance and edge weight is less than next vertex distance”, then pushing the vertex with the new distance to the priority queue. If the popped vertex is visited before, the system continues without using it. The same steps are applied again until the priority queue is empty.

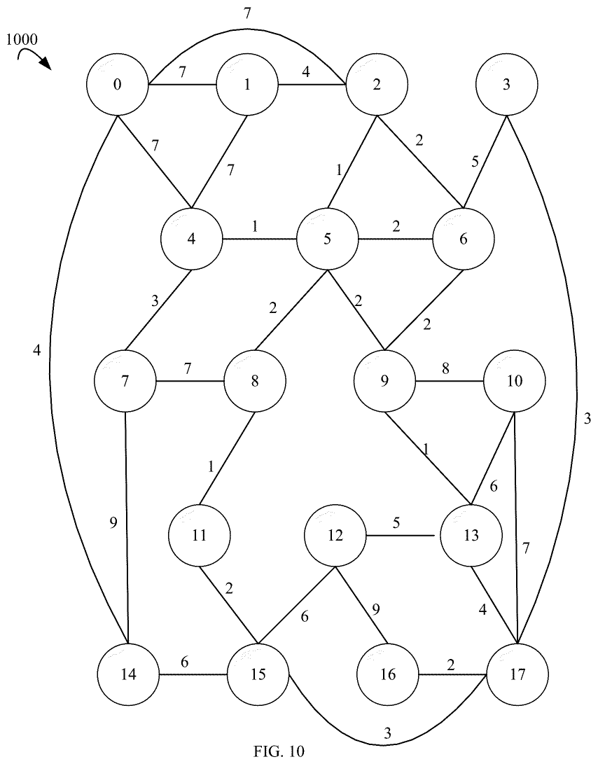

In an example embodiment, the shortest path identifier is implemented with say 18 nodes that are identified as a special tree set. FIG. 10 is a graph network 1000 showing the paths from each of the 18 nodes of the network. The input for path identifier is the start and end nodes of the graph. The code for implementing the path identifier includes creating a set sptSet (shortest path tree set) that keeps track of vertices included in shortest path tree, i.e., whose minimum distance from source is calculated and finalized. Initially, this set is empty and then assigning a distance value to all vertices in the input graph. Initializing all distance values as infinite and assigning distance value as 0 for the source vertex so that it is picked first. While sptSet doesn't include all vertices, picking a vertex u [in this case node 1] which is not there in sptSet and has minimum distance value. Then including u to sptSet and updating distance value of all adjacent vertices of u. To update the distance values, iterating through all adjacent vertices. For every adjacent vertex v, if sum of distance value of u (from source) and weight of edge u-v, is less than the distance value of v, then update the distance value of v.

In an example embodiment, the code for the path identifier is further implemented with the algorithm as below:

```
class {// A utility function to find the vertex with minimum distance value, from the set of vertices
not yet included in shortest path tree:
  static int V = 18;
  int minDistance(int[] dist, bool[ ] sptSet)
{// Initialize min value
      int min = int.Max Value, min_index = −1;
      for (int v = 0; v < V; v++)
        if (sptSet[v] == false && dist[v] <= min)
{min = dist[v]; min_index = v;}
        return min_index;}
    // A utility function to print the constructed distance array
  void printSolution(int [ ] dist, int n)
{Console.Write(″Vertex Distance ″+ ″from Source\n″);
  for (int i = 0; i < V; i++)
Console.Write(i + ″ \t\t ″ + dist[i]+ ″\n″); }
// Function that implements a single source shortest path algorithm for a graph represented using
adjacency matrix representation:
  void (int[, ] graph, int src)
{int[ ] dist = new int[V];
// The output array. dist[i] will hold the shortest distance from src to i
// sptSet[i] will true if vertex i is included in shortest path tree or shortest distance from src to i is
finalized
      bool [ ] sptSet = new bool[V];
// Initialize all distances as INFINITE and stpSet[ ] as false
for (int i = 0; i < V; i++)
{dist[i] = int.Max Value; sptSet[i] = false;}
// Distance of source vertex from itself is always 0
dist[src] = 0;
// Find shortest path for all vertices
for (int count = 0; count < V − 1; count++)
{int u = minDistance(dist, sptSet);
sptSet[u] = true;
for (int v = 0; v < V; v++)
if (!sptSet[v] && graph[u, v] != 0 &&
dist[u] != int. Max Value && dist[u] + graph[u, v] < dist[v])
dist[v] = dist[u] + graph [u, v];}
printSolution(dist, V);}
public static void Main( )
{/* The example graph discussed above is created as*/
int[, ] graph = new int[, ] { { 0, 4, 0, 0, 0, 0, 0, 8, 0 }, { 4, 0, 8, 0, 0, 0, 0, 11, 0 },
{ 0, 8, 0, 7, 0, 4, 0, 0, 2 },  { 0, 0, 7, 0, 9, 14, 0, 0, 0 }, { 0, 0, 0, 9, 0, 10, 0, 0, 0 },
{ 0, 0, 4, 14, 10, 0, 2, 0, 0 }, { 0, 0, 0, 0, 0, 2, 0, 1, 6 }, {8, 11, 0, 0, 0, 0, 1, 0, 7 },
{0, 0, 2, 0, 0, 0, 6, 7, 0 }};
GFG t = new GFG ( ); t.(graph, 0); } }
```

The expected output is as following:
The Shortest path for the nodes search to be met from 1 to all 18 nodes.
Shortest time taken and hidden anomalies identified which are avoided in the path.
Overall time taken for the shortest path taken.

It shall be apparent to a person skilled in the art that while the above algorithm describes one example of data classification and determining shortest path, there may be other algorithm that can be used to implement a similar functionality within the scope of this disclosure. The machine learning, Artificial Intelligence (AI) and NLP (natural language processing) techniques described in this disclosure are only for example and not the only way to implement the desired functionality.

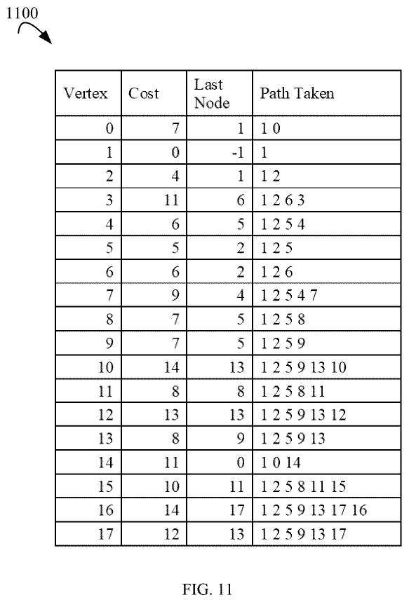

FIG. 11 is a table 1100 showing shortest path for reaching from one node of the graph network to another node in accordance with an example embodiment of the invention. The table 1100 takes the example of 18 nodes as shown in the graph structure 1000 of FIG. 10. The table 1100 provides, vertex, cost, last node, and the eventual path taken based on the graphical node structure.

In an exemplary embodiment, the AI based system and method of the present invention resolves unknown conflict scenarios related to prioritization for task execution. The conflict includes determination of data attribute or object that should take priority. There are multiple ways systems can receive a conflict, including conflict based on dates like due date, approval date, creation date etc. The input object to the data processing system contains date fields. Based on machine learning and historical data, the system identifies which task is a priority. For eg: based on high value date fields like contactSignDate or due date.

In a related embodiment, the conflict is based on the document flow, where it is to be determined which document takes precedence. Consider a case where in system received tasks for a sourcing document and a contract document. Based on the systems knowledge of the procurement system, a sourcing document task takes precedence as it is time sensitive [like a time bound auction] vs a contract document which can be taken later.

In another related embodiment, the conflict is based on specific attributes like amount, contractssigndate, inventory getting low, creation of a Purchase Order (PO), type, existing customers, high paying customer etc. Based on specific high value attributes, like if the inventory is low, then the PO task associated with that inventory item would take priority. If the amount of an invoice like a million$ vs a 100$ invoice, priority is based on Invoice Amount attribute. If we have any premium customers assisted by a broker within the system, then the tasks for a premium customer take priority to provide better customer service.

In yet another related embodiment, the conflict is based on the number of approvers or stake holders. In cases where the current user would be part of a larger group of stakeholders identified within the system, the system determines that assigning a priority for this task would service level agreement (SLA) is positively impacted.

In an exemplary embodiment, the conflict arises due to addition of a new module to the system and the data network, say like a purchase order [PO]. The PO is created based on a low code domain model and then passed along in the system. The intelligent application of the data processing system detects the data fields of the PO. Based on the field characteristics like datetime, or $amount or natural language like “deliveryduedate” the application connects it with existing module attributes based on the domain model schema. Once this has been identified with the help of data network, the data processing system is able to determine the priority based on number of times used, where is being used, if a field is being used to take decisions etc., and assign a priority of that field.

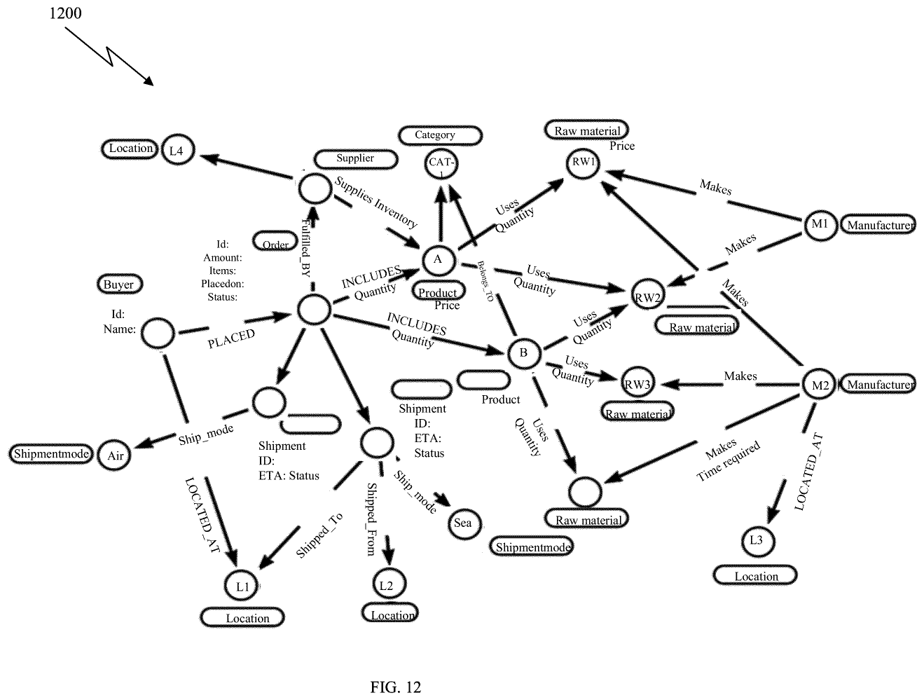

FIG. 12 is a data network diagram 1200 configured to execute operations of the task management data processing system in accordance with an embodiment of the invention. The data network as part of the data processing system is configured to generate tasks from in built collaboration tools including chatbot, messenger working with Artificial Intelligence and machine learning.

In an advantageous aspect, for offline and real-time communication between users, the data processing system of the invention includes collaboration components like Discussion Forum, Chat Messenger etc., where messages exchanged between users are within the context of the transaction and documents created in the codeless Platform. Using natural language processing, AI and Machine learning the messages are interpreted to auto create Tasks and assigned to the user. For eg: a) User to send follow up on Review of the document, b) Supplier to check with legal team to contract, or c) additional information requested by Buyer on Item specifications, etc.

In an exemplary embodiment, the present invention may be a system, a method, and/or a computer program product. The computer program product may include a computer readable storage medium (or media) having computer readable program instructions thereon for causing a processor to carry out aspects of the present invention. The media has embodied therein, for instance, computer readable program code (instructions) to provide and facilitate the capabilities of the present disclosure. The article of manufacture (computer program product) can be included as a part of a computer system/computing device or as a separate product.

The computer readable storage medium can retain and store instructions for use by an instruction execution device i.e. it can be a tangible device. The computer readable storage medium may be, for example, but is not limited to, an electromagnetic storage device, an electronic storage device, an optical storage device, a semiconductor storage device, a magnetic storage device, or any suitable combination of the foregoing. A non-exhaustive list of more specific examples of the computer readable storage medium includes the following: a hard disk, a random access memory (RAM), a portable computer diskette, a read-only memory (ROM), a portable compact disc read-only memory (CD-ROM), an erasable programmable read-only memory (EPROM or Flash memory), a digital versatile disk (DVD), a static random access memory (SRAM), a floppy disk, a memory stick, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the appended claims.

1. A data processing method for operating one or more application developed by codeless platform, the method comprising:
receiving one or more application data at a server;
identifying by one or more identification bot, at least one relevant data from the received one or more application data wherein each of the one or more identification bot is embedded to at least one of the one or more application;
generating one or more scenario by a bot coupled to an AI engine wherein at least one application module created or modified based on a codeless platform and the at least one relevant data provides a domain model structure of the at least one application module for generating the one or more scenarios; and
analyzing the one or more scenario, one or more user data associated with the one or more scenario, at least one operational logic, and one or more operation execution conflict to generate for execution one or more operations associated with the one or more scenario.

2. The method of claim 1, wherein the one or more identification bot is configured to sense relevant data by an application data script.

3. The method of claim 2, wherein the relevant data is captured from one or more application data sources including chat messenger, email, discussion forum, and sub applications facilitating text message sharing.

4. The method of claim 3, wherein the domain model includes one or more application entities with their relationship to other entities represented by associations wherein one or more annotations connected to the domain model enables identification of means by which the domain model is to be operated.

5. The method of claim 4, wherein the domain model structure captures operational information and operational rules associated with the at least one application module and the one or more applications.

6. The method of claim 5, wherein the at least one application module is one or more supply chain operation application including purchase order, invoice, sourcing, warehouse management, and inventory management.

7. The method of claim 6, wherein the one or more application data includes data from an enterprise application including functions of procurement management, supply chain management, sourcing, inventory management, warehouse management, invoice management, PO, Demand planning, Supply planning, Forecasting, Project Management, Vendor performance management, Risk Assessment management.

8. The method of claim 7, wherein the relevant data is identified based on at least one relationship of the relevant data with one or more historical data element stored in a historical data elements database wherein the at least one relationship is identified based on one or more data models associated with historical data elements database.

9. The method of claim 8, wherein a data structure metadata including views, plugins binding, rule engine data structure and BPMN data structure associated with the one or more applications are obtained from the domain model.

10. The method of claim 9, further comprises creating at least one training relationship data model from a data relationship tool by:
retrieving the historical data elements from the historical data elements database;
cleansing the historical data elements for obtaining normalized historical data;
extracting a plurality of categories from the normalized historical data for creating taxonomy of relationships associated with the one or more data attributes;
fetching a plurality of code vectors from the normalized historical data wherein the code vectors correspond to each of the extracted categories of the relationships;
extracting a plurality of distinct words from the normalized historical data to create a list of variables;
transforming normalized historical data into a training data matrix using the list of variables, and
creating the training relationship data model from the classification code vectors and the training data matrix by using the machine learning engine (MLE) and the AI engine.

11. The method of claim 10, wherein the at least one training relationship data model is an ensemble of one or more data models, the relationship data model is created by:
reading the training data matrix and the plurality of code vectors;
applying relational data model (RDM) algorithms to train one or more relational data model for the normalized historical data by using machine learning engine (MLE);
applying document model (DM) algorithms to obtain document data models by using machine learning engine (MLE);
applying graphical data model (GDM) algorithms to obtain graphical data models by using machine learning engine (MLE), and
saving RDM, DM and GDM models as the training relationship models for identification of relationships in a training model database.

12. The method of claim 11, wherein the one or more operations/task includes auto trigger transaction creation, review, approvals for invoice, Purchase Order, Requisition, Good Receipts, ASN, Contract Management, request for X (RFX), Projects, Service Confirmation, Ticketing, Credit Memo, Inventory System, Picking Request, Risk Assessment forms, New users and updated Users.

13. The method of claim 12, wherein the one or more scenarios include approval of contract document based on urgency identified through data analysis, approval of Purchase Order based on due date or quantity of inventory available in stock, and approvals for urgent transactions based on type of material as direct or indirect material required for procurement.

14. The method of claim 13, wherein the operation execution conflict includes conflict associated with supply chain management related operation/task execution process including approval process, review process, notification process, dependent transaction creation process, and actionable auto trigger process.

15. The method of claim 14, wherein the operational logic includes identification of execution path by the bot, serial data processing, parallel data processing, switching based data processing execution of the one or more operations.

16. A system for operating one or more application developed by codeless platform, the system comprises:
one or more processors; and
one or more memory devices including instructions that are executable by the one or more processor for causing the processor to
receive one or more application data at a server;
identify by one or more identification bot, at least one relevant data from the received one or more application data wherein each of the one or more identification bot is embedded to at least one of the one or more application;
generate one or more scenario by a bot coupled to an AI engine wherein at least one application module created or modified based on a codeless platform and the at least one relevant data provides a domain model structure of the at least one application module for generating the one or more scenarios; and
analyze the one or more scenario, one or more user data associated with the one or more scenario, at least one operational logic, and one or more operation execution conflict to generate for execution one or more operations associated with the one or more scenario.

17. The system of claim 16, wherein the codeless development platform includes:
a plurality of configurable components; a customization layer; an application layer; a shared framework layer; a foundation layer; a data layer; a process orchestrator; and
at least one processor configured to cause the plurality of configurable components to interact with each other in a layered architecture to
customize the one or more Supply Chain Management (SCM) application based on at least one operation to be executed using the customization layer;
organize at least one application service of the one or more Supply Chain Management (SCM) application by causing the application layer to interact with the customization layer through one or more configurable components of the plurality of configurable components, wherein the application layer is configured to organize the at least one application service of the one or more Supply Chain Management (SCM) application;
fetch shared data objects to enable execution of the at least one application service by causing the shared framework layer to communicate with the application layer through one or more configurable components of the plurality of configurable components, wherein the shared framework layer is configured to fetch the shared data objects to enable execution of the at least one application service, wherein fetching of the shared data objects is enabled via the foundation layer communicating with the shared framework layer, wherein the foundation layer is configured for infrastructure development through the one or more configurable components of the plurality of configurable components;
manage database native queries mapped to that at least one operation using a data layer to communicate with the foundation layer through one or more configurable components of the plurality of configurable components, wherein the data layer is configured to manage database native queries mapped to the at least one operation; and
execute the at least one operation and develop the one or more Supply Chain Management (SCM) application using a process orchestrator to enable interaction of the plurality of configurable components in the layered architecture.

18. The system of claim 17, wherein the identification bot/sniffer object is configured to sense relevant data by an application data script.

19. The system of claim 18, wherein the one or more application data includes data from an enterprise application including functions of procurement management, supply chain management, sourcing, inventory management, warehouse management, invoice management, PO, Demand planning, Supply planning, Forecasting, Project Management, Vendor performance management, Risk Assessment management.

20. The system of claim 19, wherein the one or more operations/task includes auto trigger transaction creation, review, approvals for invoice, Purchase Order, Requisition, Good Receipts, ASN, Contract Management, request for X (RFX), Projects, Service Confirmation, Ticketing, Credit Memo, Inventory System, Picking Request, Risk Assessment forms, New Users, and updated users.

21. The system of claim 20, wherein one or more scenarios include approval of contract document based on urgency identified through data analysis, approval of Purchase Order based on due date or quantity of inventory available in stock, and approvals for urgent transactions based on type of material as direct or indirect material required for procurement.

22. The system of claim 21, wherein the operation execution conflict includes conflict associated with supply chain management related operation/task execution process including approval process, review process, notification process, dependent transaction creation process, and actionable auto trigger process.

23. The system of claim 22, wherein the operational logic includes identification of execution path by the bot, serial data processing, parallel data processing, switching based data processing execution of the one or more operations.

24. The system of claim 16, wherein the domain model structure describes domain types for the enterprise application with associated constraints enabling reuse of common data types as the domain model structure enforces standardization across the one or more applications in relation to schema, nomenclature and validations across the applications.

25. A non-transitory computer program product for data processing to operate one or more application of a computing device with memory, the computer program product comprising a non-transitory computer readable storage medium having instructions embodied therewith, the instructions when executed by one or more processors causes the one or more processors to:
receiving one or more application data at a server;
identifying by one or more identification bot, at least one relevant data from the received one or more application data wherein each of the one or more identification bot is embedded to at least one of the one or more application;
generating one or more scenario by a bot coupled to an AI engine wherein at least one application module created or modified based on a codeless platform and the at least one relevant data provides a domain model structure of the at least one application module for generating the one or more scenarios; and
analyzing the one or more scenario, one or more user data associated with the one or more scenario, at least one operational logic, and one or more operation execution conflict to generate for execution one or more operations associated with the one or more scenario.

26. The non-transitory computer program product of claim 25, wherein the method is performed in a cloud or cloud-based computing environment.
